(19) United States
(12) Patent Application Publication
(10) Pub. No.: US 2008/0047398 A1
(43) Pub. Date: Feb. 28, 2008

(54) Strap wrench

(76) Inventor: Nigel Alexander Buchanan, By Leven (GB)

Correspondence Address: KLIMA LAW OFFICES, P.L.L.C.;A PROFESSIONAL LIMITED LIABILITY COMPANY, Patent, Trademark & Copyright Law, 2046-C JEFFERSON DAVIS HIGHWAY, STAFFORD, VA, 22554, US

(21) Appl. No.: 11/889,608

(22) Filed: Aug. 15, 2007

(30) Foreign Application Priority Data
Aug. 15, 2006 (GB) 06 16200.2

(51) Int. Cl. B25B 13/52

(52) U.S. Cl. 81/65.4; 81/64

(57) ABSTRACT

A strap wrench (10) suitable for turning an oil filter canister (16) comprises a strap (14) and a drive unit (12). The drive unit (12) has a portion (14e) of the strap secured to it and includes a toothed rotary drive element (18) and a guide surface (48). The rotary drive element (18) has a drive member connection formation (24) connectable with a rotatable input drive member. A passage (46) is defined between the guide surface (48) and rotary drive element (18) through which a free end (14e) of the strap is threaded to form a loop with teeth (22) of the rotary drive element (18) engaging the strap such that rotation of the rotary drive element imparts a pulling force to the strap that pulls the strap through the passage to tighten the loop onto the oil filter canister and apply a turning force to the canister. The strap wrench (10) can be used to apply a turning force to a generally cylindrical surface of other objects such as a tube or pipe.

### CROSS REFERENCE TO RELATED APPLICATIONS

The present application claims benefit of United Kingdom Patent Application No 06 0616200.2, which is hereby incorporated herein by reference in its entirety.

### FIELD OF THE INVENTION

The invention relates to strap wrenches such as may, for example, be used to apply a torque to canister type oil filters commonly used on automobile engines or to fitted pipes or tubes.

### BACKGROUND TO THE INVENTION

Oil filter canisters can be difficult to remove as they may require considerable torque to overcome the initial turning resistance. Often the locations in which oil canisters are found require that the release torque can be applied remotely and/or that the tool used is relatively compact. Known chain type filter wrenches whilst strong are often too bulky for use in such locations. Known strap wrenches seldom grip the oily canister surface with sufficient force to guarantee removal of the canister.

### SUMMARY OF THE INVENTION

The invention provides a strap wrench for turning an object by applying a turning force to a generally cylindrical surface of the object, said strap wrench comprising a drive unit and a strap having a free end and a portion secured to the drive unit, said drive unit comprising a rotary drive device and a guide surface, said rotary drive device comprising a drive member connection formation for connecting the rotary drive device with a rotatable input drive member and drive applying formations for applying a force to said strap and a passage being defined between said guide surface and rotary drive device through which passage said free end of the strap is threaded to form a loop with drive applying formations of the rotary drive device engaging the strap such that rotation of the rotary drive device imparts a pulling force to the strap that pulls the strap through the passage to tighten the loop onto the generally cylindrical surface and apply a turning force to the generally cylindrical surface by which turning force the object is turned.

The invention also includes a strap wrench for turning an object by applying a turning force to a generally cylindrical surface of the object, said strap wrench comprising:
a strap having a surface provided with teeth; and
a drive unit that comprises a rotatable cylinder mounted between opposed support members, a spacer member extending between said support members and at least one gripping member connected with the support members for gripping a portion of the strap to secure said portion to the support members, wherein
said rotatable cylinder is provided with a plurality of teeth disposed around the circumference thereof and at least one axially extending drive member connection formation for connection to an input drive member used for applying a drive force to rotate the rotatable cylinder and said spacer member is disposed opposite said rotatable cylinder to define a passage therebetween through which a free end of said strap is passed to form the strap into a loop that extends between the secured portion and the passage with teeth of said rotatable cylinder engaging teeth of the strap such that rotation of the rotatable cylinder is transmitted to the teeth of the strap to cause the strap to be pulled through the passage to reduce the size of the loop for tightening the loop onto a said generally cylindrical surface and impart a turning force thereto by which said object is turned.

The invention also includes a method of turning a part by applying a turning force to a generally cylindrical surface of the part using a strap wrench comprising a strap and a drive unit, said method comprising:
locating a strap loop around said generally cylindrical surface of the part, said strap loop being defined by having a portion of said strap secured to said drive unit and a free end of the strap threaded through a passage defined by a guide surface and a toothed rotatable drive member of the drive unit which rotatable drive member has teeth engaging the strip in the passage;
connecting a rotatable input drive device to a drive member connection formation of the rotatable drive member; and
operating said input drive device to rotate said rotatable drive member in a first direction so as to cause the teeth of the rotatable drive member engaging the strap to apply a force to the strap that moves the strap through the passage to tighten the strap loop about the generally cylindrical surface and apply a turning force thereto by means of which said part is turned.

### BRIEF DESCRIPTION OF THE DRAWINGS

In order that the invention may be well understood, some embodiments thereof, which are given by way of example only, will now be described with reference to the drawings in which:

FIG. 1 is a perspective view of a strap wrench applied to an oil filter canister;

FIG. 2 is a plan view of the strap wrench of FIG. 1 with a support member removed to show otherwise hidden features of the strap wrench;

FIG. 3 is a perspective view of a drive unit of the strap wrench of FIG. 1;

FIG. 4 is an exploded view of the drive unit of FIG. 3; and

FIG. 5 is a plan view of another strap wrench shown applied to an oil filter canister with a support member removed to show otherwise hidden features of the wrench.

### DETAILED DESCRIPTION OF THE ILLUSTRATED EMBODIMENTS

In the description that follows, the following reference numerals are used to identify features shown in the drawings:

| | | | |
|---|---|---|---|
| 10, 100 | Strap wrench | 12 | Drive unit |
| 14 | Strap | 14e | End region of strap |
| 14f | Free end of strap | 16 | Oil filter canister |
| 18 | Rotary drive element | 20 | Stub axle |
| 22 | Rotary drive element | 24 | Drive member connection |
| | teeth | | formation |
| 25 | Extension bar | 26 | Ratchet wrench |
| 27 | Support member | 28 | Bush |
| 30 | Spacer member | 32 | Tongue |
| 34 | Slot for tongue | 36 | Locking pin |
| 38 | Holes for locking pins | 40 | Teeth of the strap |
| 42 | Strap edges | 44 | Recesses between strap teeth |
| 46 | Passage | 48 | Guide surface |
| 50 | Extension guide surface | 52 | Second spacer member |
| 54 | Slot for second spacer | | |
| | member tongue. | | |

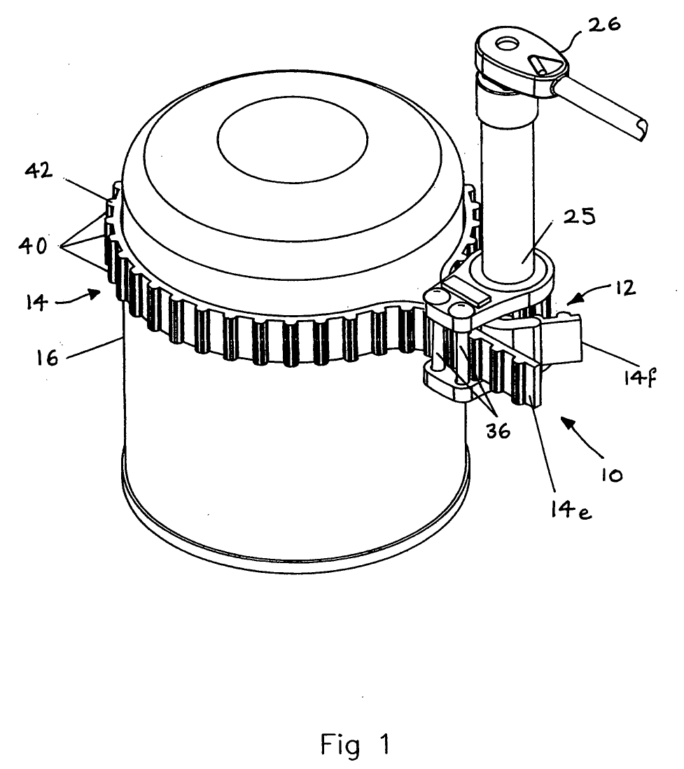

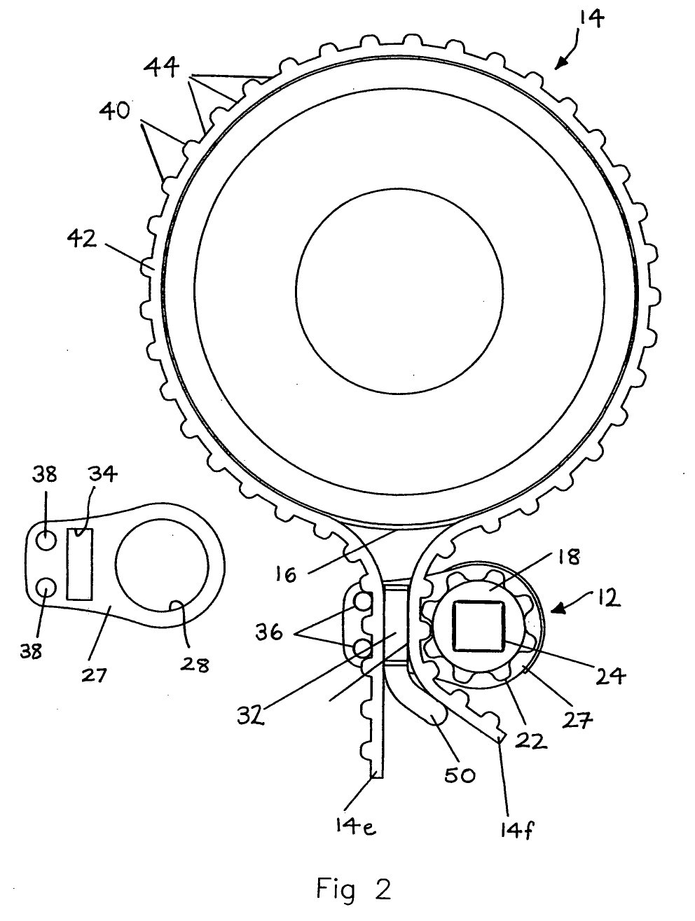

FIGS. 1 to 4 show a strap wrench 10 comprising a drive unit 12 and a strap 14. In FIGS. 1 and 2, the strap 14 is shown engaging a circumferential, or side surface of an oil filter canister 16.

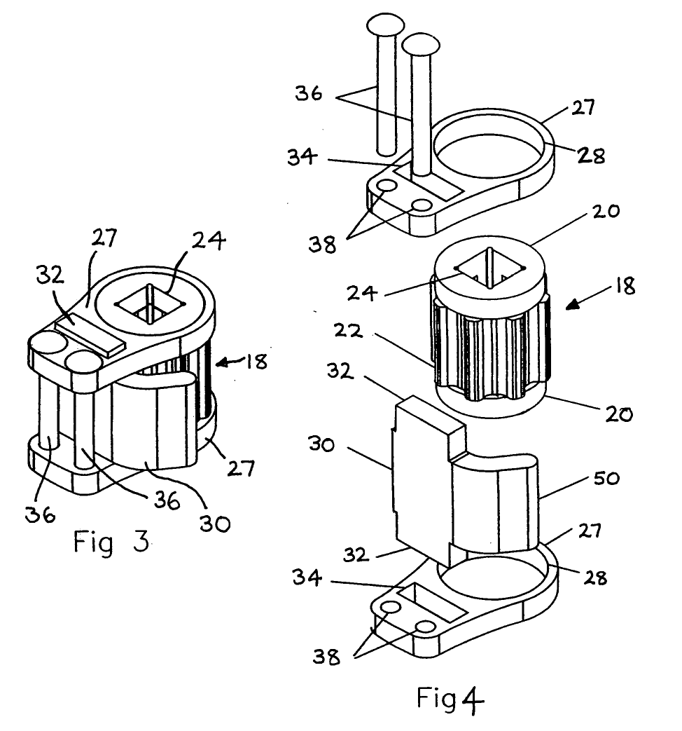

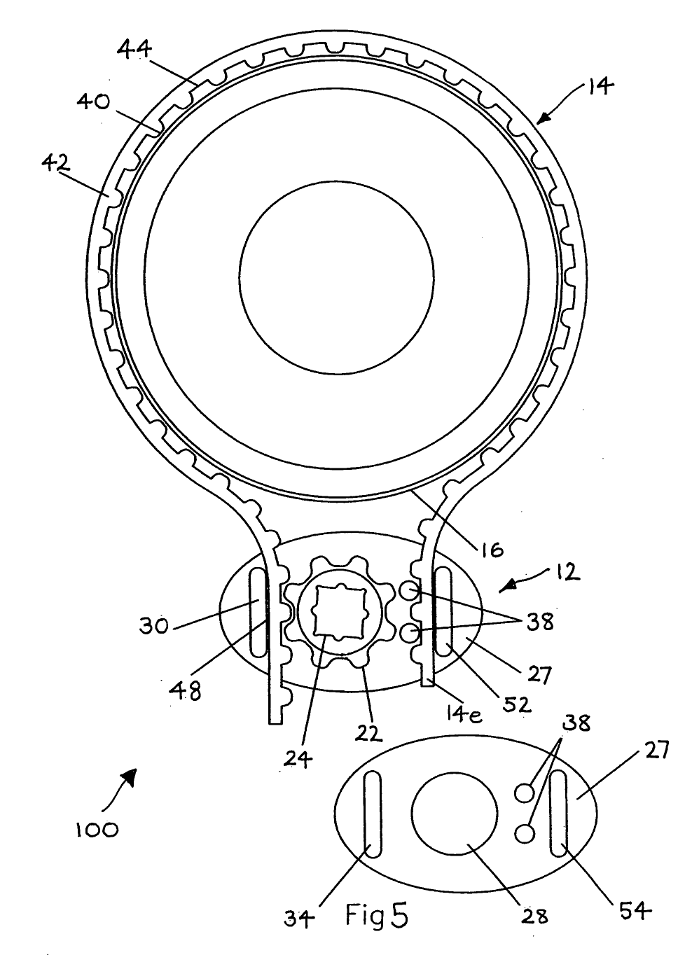

As best seen in FIGS. 3 and 4, the drive unit 12 comprises a toothed rotary drive element 18. The rotary drive element 18 comprises a generally cylindrical body member provided with stub axles, or bearing portions, in the form of respective reduced diameter portions 20 disposed at the ends of the cylindrical body member. The rotary drive element 18 has a plurality of teeth 22 disposed at regular intervals around the periphery of the cylindrical body member. The teeth 22 are disposed substantially parallel to the axis of rotation of the rotary drive element 18 and extend from one stub axle 20 to the other. The rotary drive element 18 is provided with a drive member connection formation 24 in the form of an axially extending through-hole. The drive receiving formation 24 has a rectangular cross-section sized to cooperably engage an extension bar 25 (FIG. 1) of a ratchet type wrench 26 such that a torque applied by the ratchet wrench causes the rotary drive element 18 to rotate in the direction in which the torque is applied.

The drive unit 12 additionally comprises two support members 27 for the rotary drive element 18. The support members 27 define respective through-holes that serve as bushes 28 in which the stub axles 20 are received such that the rotary drive element is rotatable relative to the support members.

A spacer member 30 is fitted between the support members 27. The spacer member 30 has respective tongues 32 at its ends that engage in respective slots 34 provided in the support members 27. When assembled the spacer member 30 is disposed perpendicular to the support members 26 and serves to maintain the support members in parallel spaced apart relation so that the rotary drive element 18 is free to rotate in the bushes 28. The spacer member 30 may be fixed to the two support members 27 by any convenient means such as, for example, welding or riveting.

The drive unit 12 comprises two locking pins 36 that pass through respective through-holes 38 provided in the upper (as viewed in FIGS. 1, 3 and 4) of the two support members 27 and into opposed holes 38 provided in the lower of the two support members. As explained in more detail below, the locking pins 36 are used to secure an end region 14e (FIG. 1) of the strap 14 to the drive unit 12. The locking pins 36 may be made releaseably securable to the support members 27 by, for example, providing their leading ends with threading for engaging in threading provided in the holes 38 in the lower of the two support members. In this way, the pins can easily be removed to allow a new strap 14 to be fitted should this prove desirable, for example, due to damage to or contamination of the existing strap. Alternatively, the locking pins 36 can be permanently fixed to the support members 26.

The strap 14 is a flexible elongate member. In the illustrated embodiment, it is a reinforced rubber strip provided on one major surface with a plurality of equi-spaced teeth 40. The teeth 40 are shaped to cooperably engage the teeth 22 of the rotary drive element 18. The teeth 40 are provided along the entire length of the strap 14 and each tooth extends between the edges 42 of the strap 14 and perpendicular to the longitudinal axis of the strap. As shown in FIGS. 1 and 2, an end region of the strap 14 is secured to the drive unit 12 by the locking pins 36 engaging in the recesses 44 defined between adjacent teeth 40.

In use, the free end 14f of the strap 14 is threaded through a passage 46 defined between the rotary drive element 18 and the surface 48 of the spacer member 30 that faces the rotary drive element. The surface 48 acts as a bearing or guide surface for the strap 14. Inserting the free end of the strap 14 into the passage 46 forms a strap loop that extends between the portion that is secured by the locking pins 36 and the portion that enters the passage 46.

With the strap loop slightly oversize for the oil filter canister 16, the strap loop is fitted over the canister so that the smooth inner surface of the strap engages the side surface of the canister and the teeth 40 project generally radially outwardly of the strap loop. Once the strap loop is fitted over the oil filter canister as illustrated in FIGS. 1 and 2, the ratchet wrench extension bar 25 is push-fitted into the drive member connection formation 24. The ratchet wrench 26 is then operated to rotate the rotary drive element 18 anti-clockwise (as viewed in FIGS. 1 and 2). As the rotary drive element 18 rotates anti-clockwise, its teeth 22 engage the teeth 40 of the strap 14 and impart a pulling force to the strap 14 that pulls the strap through the passage 46 to tighten the strap loop onto the oil filter canister. As the strap 14 is pulled through the passage 46 it runs over the guide surface 48, which ensures that contact with the rotary drive element is maintained and separates the driven portion of the strap from the end region 14e that is secured to the drive unit. Preferably, as shown, the spacer member 30 includes a curved extension guide surface 50 that is arranged to guide the free end 14f of the strap away from the end region 14e.

Continued operation of the ratchet wrench 26 applies a torque to the oil filter canister via the drive unit 12 and strap 14 that causes the canister to rotate anti-clockwise breaking the seal against the engine block and allowing its removal from the engine. If necessary, the ratchet wrench 26 can be operated to rotate the rotary drive element 18 clockwise to relax the grip of the strap 14 on the oil filter canister 16 so that the strap wrench 10 can be repositioned by sliding it around the circumferential surface of the canister. The ratchet wrench 26 can then be operated to apply an anti-clockwise torque as before to further undo the oil filter canister 16.

In FIGS. 1 and 2, the strap wrench 10 is shown oriented so as to be able to apply an anti-clockwise torque to the oil filter canister 16 for removing it from the piece of machinery, such as an engine, to which it is fitted. If the user wishes to apply a clockwise torque, all that he/she need do is turn the strap wrench upside down so that, as viewed in FIGS. 1 and 2, the rotary drive element 18 is to the left and the locking pins 36 are to the right.

Referring to FIG. 5, a second strap wrench 100 is shown gripping a circumferential, side surface of an oil filter canister 16. Many parts of the strap wrench 100 are the same as, or similar to, parts of the strap wrench 10 and so, to avoid repetition of description, are identified by identical reference numerals.

The strap wrench 100 differs from the strap wrench 10 in that it has a second spacer member 52 and the toothed rotary drive element 18 is disposed between the two spacer members 30, 52. In the same way as the spacer member 30 the spacer member 52 has tongues at each end that fit into respective slots 54 provided in the support members 27. As with the strap wrench 10, the spacer member 30 cooperates with the toothed rotary drive element 18 to define the passage 46 for the free end 14f of the strap. However, it is not used in securing the strap 14 to the drive unit 12. Instead, the locking pins 36 trap the end region 14e of the strap against the second spacer member 52. With this arrangement, the strap is inverted so the teeth 40 of the strap 14 engage the circumferential side surface of the oil filter canister 16. This may have advantages in making strap easier to manoeuvre against the canister side. Operation of the strap wrench 100 is the same as that described above for the strap wrench 10.

It will be appreciated that when the rotary drive element is rotated to pull the free end of the strap through the passage defined between the drive element and the guide surface on the spacer member, the strap is drawn over the guide surface, which is preferably smooth so as to reduce the friction between it and the strap so that less of the torque applied by the ratchet wrench is wasted in overcoming friction between parts of the strap wrench.

It will be appreciated that while conveniently the passage for the free end of the strap is defined between the spacer member and the rotary drive element, the passage could instead be defined between the rotary drive element and another surface provided on the drive unit. It will also be understood that the width and height of the passage should be such that the force required to turn the rotary drive element so as to pull the strap through the passage is as low as possible so that as much of the applied torque as is possible is applied to turning the part that is to be turned.

It will be appreciated that the strap may be made of any flexible material that will bend around the circumferences the wrench is intended to work on. Typically, the strap will be a reinforced polymer belt. The strap may be cut from used camshaft belting thus allowing such belting to be recycled.

It will be appreciated that while conveniently the strap has teeth along its entire length, teeth may be provided just at the free end to provide a sufficient pull length for the sizes of article the strap wrench is intended to be used on.

It will be appreciated that the rotary drive element of the drive unit does not have to be provided with teeth as shown in the drawings. The rotary drive element may be provided with other formations that engage, typically projections, the strap to pull it though the passage. Similarly, the strap may be provided with complementary formations for engaging the drive unit formations.

Typically, the parts of the drive unit will be made of chromed steel. However, it will be appreciated that other materials can be used and that for some applications, engineering plastics might be used.

In the drawings, the strap wrenches are shown applied to an oil filter canister. It will be appreciated that the strap wrenches can be applied to many parts having circumferential surfaces, such as pipes and tubes, and that the surfaces to which it is applied do not have to define a circle or be of a particular size. There is, thus, provided a tool that provides considerable flexibility for use.

In the embodiments, the drive member connection formation is a rectangular section through-hole. Alternatively, respective rectangular section recesses could be provided in the ends of the rotary drive element. It will also be appreciated that the drive member connection formation(s) may be of any suitable shape and size to receive any desired shape and size of input drive member. Alternatively the drive member connection formation could be a projection for fitting into a drive socket of an input drive member. Of course, for a unidirectional strap wrench, there only needs to be a drive member connection formation at one end of the rotary drive element.

It will be understood that although the strap wrench is shown in FIG. 1 with the input torque applied by a ratchet wrench via an extension bar, this is not essential. For example, where there is suitable access, the ratchet wrench might be applied directly to the strap wrench and tools other than a ratchet wrench could be used to apply the input torque.

It will be appreciated that the drive unit can be made compact allowing it to be used to apply a torque to objects around which there is very little free space. In some embodiments, the drive unit has a maximum width in a direction perpendicular to the passage that is not substantially greater than twice the diameter of the toothed portion of the rotary drive element. In some embodiments, the drive unit has a maximum length in a direction parallel to the direction of the passage that is not substantially greater than one point five, preferably not substantially greater than one point two five times the diameter of the toothed portion of the rotary drive element.

1. A strap wrench for turning an object by applying a turning force to a generally cylindrical surface of the object, said strap wrench comprising a drive unit and a strap having a free end and a portion secured to the drive unit, said drive unit comprising a rotary drive device and a guide surface, said rotary drive device comprising a drive member connection formation for connecting the rotary drive device with a rotatable input drive member and drive applying formations for applying a force to said strap and a passage being defined between said guide surface and rotary drive device through which passage said free end of the strap is threaded to form a loop with drive applying formations of the rotary drive device engaging the strap such that rotation of the rotary drive device imparts a pulling force to the strap that pulls the strap through the passage to tighten the loop onto the generally cylindrical surface and apply a turning force to the generally cylindrical surface by which turning force the object is turned.

2. A strap wrench as claimed in claim 1, wherein said drive member connection formation comprises an axially extending recess provided in said rotary drive device.

3. A strap wrench as claimed in claim 1, wherein said drive unit comprises two support members disposed in parallel spaced apart relation and said rotary drive device comprises bearing portions rotabably received in respective bores provided in said support members.

4. A strap wrench as claimed in claim 3, wherein said drive unit comprises a spacer member extending between said support members to maintain said spaced apart relationship, said portion of the strap secured to the drive unit being toothed and secured to the drive unit by at least one pin that extends between said support members and engages between adjacent teeth of said portion such that said portion is trapped between said at least one pin and the spacer member.

5. A strap wrench as claimed in claim 4, wherein said guide surface is defined by said spacer member.

6. A strap wrench as claimed in claim 4, comprising a second spacer member, said rotary drive device being disposed between said spacer members and said guide surface being provided on said second spacer member.

7. A strap wrench as claimed claim 1, wherein said rotary drive device comprises a cylindrical member having a plurality of said drive applying formations regularly spaced around the circumference thereof.

8. A strap wrench as claimed in claim 7, wherein said cylindrical member has a diameter and the drive unit has a maximum width in a direction perpendicular to said passage, said maximum width being not substantially greater than two times said diameter.

9. A strap wrench as claimed in claim 7, wherein said cylindrical member has a diameter and the drive unit has a maximum length in a direction parallel to said passage, said maximum length being not substantially greater than one point five times, preferably not greater than one point two five times, said diameter.

10. A strap wrench as claimed in claim 1, wherein said drive applying formations comprise teeth.

11. A strap wrench as claimed in claim 1, wherein said strap has a toothed face and said drive applying formations engage said toothed face.

12. A strap wrench as claimed in claim 1, further comprising a second guide surface downstream of said passage and arranged to guide said free end of the strap in a direction away from said portion of the strap secured to the drive unit.

13. A strap wrench for turning an object by applying a turning force to a generally cylindrical surface of the object, said strap wrench comprising:
a strap having a surface provided with teeth; and
a drive unit that comprises a rotatable cylinder mounted between opposed support members, a spacer member extending between said support members and at least one gripping member connected with the support members for gripping a portion of the strap to secure said portion to the support members, wherein
said rotatable cylinder is provided with a plurality of teeth disposed around the circumference thereof and at least one axially extending drive member connection formation for connection to an input drive member used for applying a drive force to rotate the rotatable cylinder and said spacer member is disposed opposite said rotatable cylinder to define a passage therebetween through which a free end of said strap is passed to form the strap into a loop that extends between the secured portion and the passage with teeth of said rotatable cylinder engaging teeth of the strap such that rotation of the rotatable cylinder is transmitted to the teeth of the strap to cause the strap to be pulled through the passage to reduce the size of the loop for tightening the loop onto a said generally cylindrical surface and impart a turning force thereto by which said object is turned.

14. A strap wrench as claimed in claim 13, wherein said at least one gripping member comprises a pin that extends between said support members and is received in a recess defined between adjacent teeth of the strap.

15. A strap wrench as claimed in claim 13, wherein said spacer member comprises a guide surface disposed downstream of said passage for guiding said free end in a direction away from said portion of the strap secured to the drive unit.

16. A strap wrench as claimed in claim 13, wherein said rotatable cylinder has a reduced diameter portion at each end thereof, said reduced diameter portions being rotatably received in respective openings provided in said support members.

17. A strap wrench as claimed in claim 13, further comprising a ratchet wrench, said ratchet wrench being connectable to said at least one drive formation.

18. A method of turning a part by applying a turning force to a generally cylindrical surface of the part using a strap wrench comprising a strap and a drive unit, said method comprising:
locating a strap loop around said generally cylindrical surface of the part, said strap loop being defined by having a portion of said strap secured to said drive unit and a free end of the strap threaded through a passage defined by a guide surface and a toothed rotatable drive member of the drive unit which rotatable drive member has teeth engaging the strip in the passage;
connecting a rotatable input drive device to a drive member connection formation of the rotatable drive member; and
operating said input drive device to rotate said rotatable drive member in a first direction so as to cause the teeth of the rotatable drive member engaging the strap to apply a force to the strap that moves the strap through the passage to tighten the strap loop about the generally cylindrical surface and apply a turning force thereto by means of which said part is turned.

19. A method as claimed in claim 18, comprising operating said input drive device in a second direction that is opposite to said first direction to relax said strap loop and sliding said relaxed strap loop about said generally cylindrical surface to reposition said strap loop with respect to said generally cylindrical surface.

20. A method as claimed in claim 18, wherein said input drive device comprises a ratchet bar and an elongate extension bar extending between said ratchet bar and said drive member connection formation.
